(19) United States
(12) Patent Application Publication
(10) Pub. No.: US 2026/0016373 A1
(43) Pub. Date: Jan. 15, 2026

(54) ABNORMALITY DIAGNOSIS DEVICE FOR INTERNAL COMBUSTION ENGINE

(71) Applicant: TOYOTA JIDOSHA KABUSHIKI KAISHA, Toyota-shi (JP)

(72) Inventors: Naoya OKUBO, Chiryu-shi (JP); Tomoyuki TSUJI, Nagakute-shi (JP)

(21) Appl. No.: 19/220,090

(22) Filed: May 28, 2025

(30) Foreign Application Priority Data
Jul. 11, 2024 (JP) 2024-111719

(51) Int. Cl. G01M 15/09; F02M 25/06

(52) U.S. Cl. CPC G01M 15/09; F02M 25/06

(57) ABSTRACT

An abnormality diagnosis device diagnoses the presence or absence of an abnormality in an internal combustion engine. The internal combustion engine includes a dry sump lubrication system that circulates lubricating oil between the internal combustion engine and an oil tank outside the internal combustion engine. The internal combustion engine recirculates blow-by gas in the oil tank to the intake passage. The abnormality diagnosis device includes a pressure sensor that detects a tank internal pressure that is a pressure inside the oil tank. The abnormality diagnosis device is configured to perform a diagnosis process that diagnoses presence or absence of an abnormality in a recirculation path of the blow-by gas based on whether the tank internal pressure at the time of a low-load operation of the internal combustion engine exceeds a threshold value.

### CROSS-REFERENCE TO RELATED APPLICATIONS

This application is based upon and claims the benefit of priority from Japanese Patent Application No. 2024-111719, filed on Jul. 11, 2024, the entire contents of which are incorporated herein by reference.

### BACKGROUND

### 1. Field

The present disclosure relates to an abnormality diagnosis device for an internal combustion engine including a dry sump lubrication system.

### 2. Description of Related Art

Japanese Laid-Open Patent Publication No. 2009-68452 discloses an abnormality diagnosis device for a dry sump internal combustion engine, which stores lubricating oil in an external oil tank. In this abnormality diagnosis device, an electrical resistor is disposed in piping that connects the oil tank to the internal combustion engine, and the resistance value of the electrical resistor is monitored to detect disconnection or breakage of the piping.

Holes can sometimes form in the piping. In that case, gas and/or lubricating oil may leak. The above-described abnormality diagnosis device is incapable of detecting the presence of such holes in the piping.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an abnormality diagnosis device is configured to diagnose presence or absence of an abnormality in an internal combustion engine. The internal combustion engine includes a dry sump lubrication system that circulates lubricating oil between the internal combustion engine and an oil tank outside the internal combustion engine. The internal combustion engine is configured to recirculate blow-by gas in the oil tank to an intake passage. The abnormality diagnosis device includes a pressure sensor that detects a tank internal pressure that is a pressure inside the oil tank. The abnormality diagnosis device is configured to perform a diagnosis process that diagnoses presence or absence of an abnormality in a recirculation path of the blow-by gas based on whether the tank internal pressure at a time of a low-load operation of the internal combustion engine exceeds a threshold value.

The above-described abnormality diagnosis device for an internal combustion engine has the capability to diagnose abnormalities in a recirculation path that returns blow-by gas from the oil tank to the intake passage. This diagnostic ability includes detecting holes in the piping that constitutes the recirculation path.

Other features and aspects will be apparent from the following detailed description, the drawings, and the claims.

### BRIEF DESCRIPTION OF THE DRAWINGS

FIG. 1 is a diagram schematically showing the configuration of an abnormality diagnosis device for an internal combustion engine according to a first embodiment.

FIG. 2 is a flowchart of a diagnosis process performed by the abnormality diagnosis device shown in FIG. 1.

FIG. 3 is a flowchart of a diagnosis process performed by an abnormality diagnosis device for an internal combustion engine according to a second embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

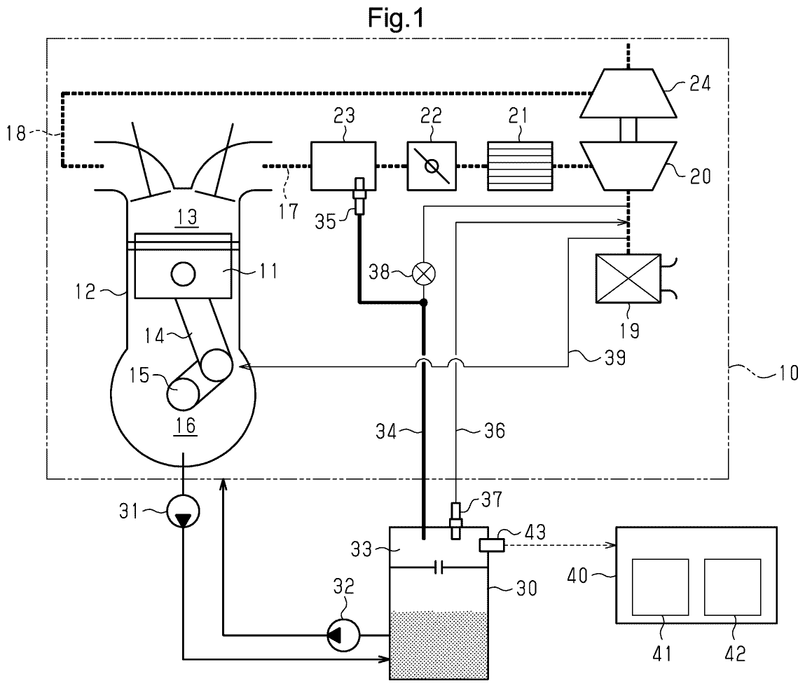

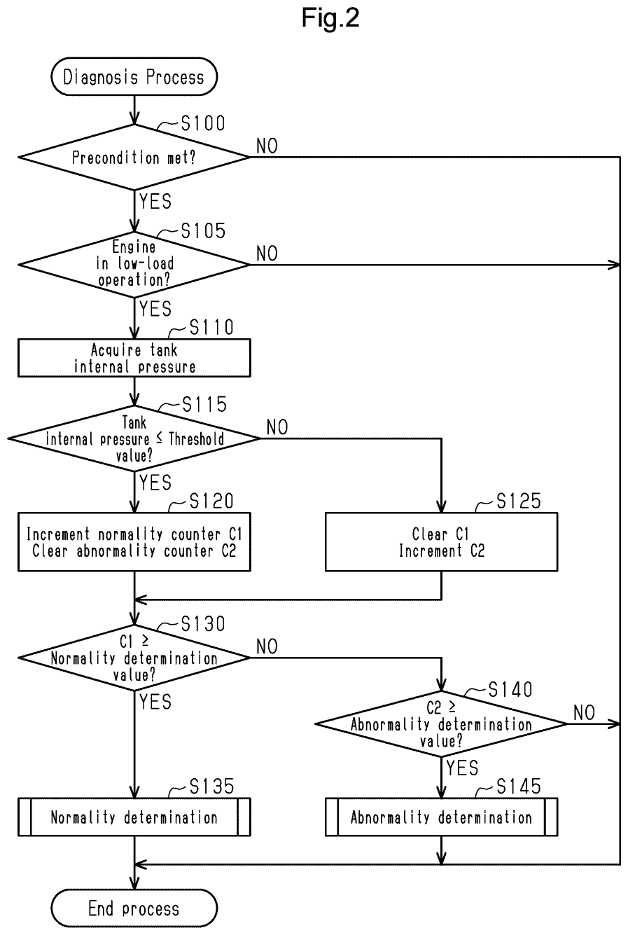

Hereinafter, a first embodiment of an abnormality diagnosis device for an internal combustion engine will be described in detail with reference to FIGS. 1 and 2.

### Configuration of Abnormality Diagnosis Device for Internal Combustion Engine

A configuration of an abnormality diagnosis device for an internal combustion engine of the present embodiment will be described with reference to FIG. 1.

First, a configuration of an internal combustion engine 10 to which an abnormality diagnosis device of the present embodiment is applied will be described. The internal combustion engine 10 includes a cylinder 12 in which a piston 11 is disposed so as to be capable of reciprocating. Inside the cylinder 12, a combustion chamber 13 for burning an air-fuel mixture is defined by the piston 11. The piston 11 is connected to a crankshaft 15, which is an output shaft of the internal combustion engine 10, via a connecting rod 14. A crankcase 16 that houses a crankshaft 15 is provided in a portion of the internal combustion engine 10 below the cylinder 12 in the drawing. The internal combustion engine 10 actually has a plurality of cylinders 12, only one of which is shown in FIG. 1. The combustion chamber 13 is connected to an intake passage 17, which is a passage for introducing intake air, and an exhaust passage 18, which is a passage for discharging exhaust gas. The intake passage 17 is provided with an air cleaner 19, a compressor 20, an intercooler 21, a throttle valve 22, and an intake manifold 23. The exhaust passage 18 is provided with a turbine 24 which is rotated by the flow of the exhaust gas. The air cleaner 19 is a filter device that filters dust and the like in intake air. The compressor 20 compresses intake air that has passed through the air cleaner 19 by rotating in conjunction with the turbine 24. The intercooler 21 cools the intake air having a high temperature due to the compression by the compressor 20. The throttle valve 22 is a valve for adjusting the flow rate of intake air in the intake passage 17, and is installed in a portion of the intake passage 17 downstream of the intercooler 21. The intake manifold 23 is a branch pipe that distributes the intake air that has passed through the throttle valve 22 to the combustion chambers 13 of the cylinders 12.

### Configuration of the Lubrication System of the Internal Combustion Engine 10

Next, a configuration of a lubrication system of the internal combustion engine 10 will be described. The internal combustion engine 10 has a dry sump lubrication system. The dry sump lubrication system includes an oil tank 30 installed outside the internal combustion engine 10. The lubrication system is configured to circulate the lubricating oil between the oil tank 30 and the internal combustion engine 10 by the scavenge pump 31 and the supply pump 32. The scavenge pump 31 delivers the lubricating oil from the crankcase 16 to the oil tank 30. The supply pump 32 supplies the lubricating oil stored in the oil tank 30 to the internal combustion engine 10. The oil tank 30 is provided with a pressure sensor 43 for detecting the pressure inside the oil tank 30. In the following description, the pressure inside the oil tank 30 is referred to as a tank internal pressure.

### Ventilation System

The lubricating oil delivered to the oil tank 30 by the scavenge pump 31 is mixed with blow-by gas containing combustion gas that has leaked from the combustion chamber 13 to the crankcase 16. The internal combustion engine 10 includes a ventilation system that recirculates the blow-by gas flowing into the oil tank 30 into the intake air.

The ventilation system includes two paths of a first recirculation path 34 and a second recirculation path 36 as paths for recirculating the blow-by gas from the oil tank 30 to the intake passage 17. The first recirculation path 34 and the second recirculation path 36 are constituted by piping such as hoses and pipes, and a PCV valve described later. An end portion of the first recirculation path 34 corresponding to the intake passage 17 is connected to the intake manifold 23. On the other hand, an end portion of the second recirculation path 36 corresponding to the intake passage 17 is connected to a portion of the intake passage 17 downstream of the air cleaner 19 and upstream of the compressor 20. A first PCV valve 35 and a second PCV valve 37, which are one-way valves for preventing backflow of intake air from the intake passage 17 to the oil tank 30, are installed in the first recirculation path 34 and the second recirculation path 36, respectively. The first PCV valve 35 is provided at a connecting portion of the first recirculation path 34 connected to the intake manifold 23. On the other hand, the second PCV valve 37 is provided at a connecting portion of the second recirculation path 36 connected to the oil tank 30. The oil tank 30 is provided with an oil separator 33 for separating oil mist in the blow-by gas. The oil tank 30 is configured to deliver the blow-by gas to the first recirculation path 34 and the second recirculation path 36 via the oil separator 33.

The ventilation system further includes a vent valve 38 and an atmospheric introduction passage 39. When opened, the vent valve 38 allows a portion of the intake passage 17 downstream of the air cleaner 19 and upstream of the compressor 20 to communicate with the oil tank 30. The vent valve 38 is provided to open when the internal combustion engine 10 is stopped so as to bring the tank internal pressure close to the atmospheric pressure. The atmospheric introduction passage 39 is a passage that communicates a portion of the intake passage 17 downstream of the air cleaner 19 and upstream of the compressor 20 with the crankcase 16.

In the internal combustion engine 10 of FIG. 1, the blow-by gas in the crankcase 16 is sent to the oil tank 30 together with the lubricating oil by the scavenge pump 31. In response to the delivery of the blow-by gas at this time, fresh air is supplied to the crankcase 16 through the atmospheric introduction passage 39. During low-load operation of the internal combustion engine 10, the pressure inside the intake manifold 23 (hereinafter, referred to as intake manifold pressure) becomes a negative pressure. The blow-by gas in the oil tank 30 at this time is sucked into the intake manifold 23 through the first recirculation path 34 by the negative pressure. When the load of the internal combustion engine 10 increases and shifts to the supercharging operation, the intake manifold pressure becomes a positive pressure, and the suction of the blow-by gas through the first recirculation path 34 stops. When the blow-by gas continues to be sent from the crankcase 16 to the oil tank 30 by the scavenge pump 31 in this state, the tank internal pressure increases. During the supercharging operation as well, the pressure in the portion of the intake passage 17 upstream of the compressor 20 is maintained near the atmospheric pressure. Therefore, when the tank internal pressure exceeds the atmospheric pressure and becomes a positive pressure, the blow-by gas in the oil tank 30 is sent to the intake passage 17 through the second recirculation path 36. As described above, in the internal combustion engine 10 of FIG. 1, the crankcase 16 is ventilated by recirculating the blow-by gas in the crankcase 16 into the intake air via the oil tank 30.

### Configuration of Abnormality Diagnosis Device

The internal combustion engine 10 is controlled by an engine control module (ECM) 40. The ECM 40 includes a storage 41 that stores a program and date for engine control, and a processor 42 that executes the program. The ECM 40 controls the internal combustion engine 10 by causing the processor 42 to execute a program stored in a storage 41. Detection results of various sensors for detecting the operation state of the internal combustion engine 10 are input to the ECM 40. The sensor whose detection result is input to the ECM 40 includes the above-described pressure sensor 43.

### Diagnosis Process

The ECM 40 performs a diagnosis process for diagnosing the presence or absence of an abnormality in the first recirculation path 34 as part of the control of the internal combustion engine 10. The abnormality of the first recirculation path 34, which is a diagnosis target in the diagnosis process, includes holes and detachment of piping constituting the first recirculation path 34, and for example, valve-closed sticking of the first PCV valve 35.

FIG. 2 shows a flowchart of the diagnosis process. During the operation of the internal combustion engine 10, the ECM 40 repeatedly executes the processing of FIG. 2 for each predetermined control cycle.

When the process of FIG. 2 is started, first, in step S100, the ECM 40 determines whether a precondition for diagnosing is met. In the case of the present embodiment, the precondition for the abnormality diagnosis is that all of the requirements necessary for performing the abnormality diagnosis are met. Examples of the requirements necessary for the execution of the abnormality diagnosis include that the warm-up of the internal combustion engine 10 has been completed, that the atmospheric pressure is equal to or higher than a certain pressure, and that the vent valve 38 is closed. If the precondition is met (YES), the ECM 40 advances the process to step S105. If the precondition is not met (NO), the SL ends the abnormality diagnosis process in the current control cycle.

In step S105, the ECM 40 determines whether the internal combustion engine 10 is in low-load operation. For example, the ECM 40 determines that the internal combustion engine 10 is in the low-load operation when the rotation speed of the internal combustion engine 10 is equal to or lower than a predetermined value and the load factor is equal to or lower than a predetermined value. The ECM 40 advances the process to step S110 when the engine is in the low-load operation (YES), and ends the process of abnormality diagnosis in the current control cycle when the engine is not in the low-load operation (NO). The low-load operation herein refers to an operation state of the internal combustion engine 10 in which the intake manifold pressure is lower than a certain level.

In step S110, the ECM 40 acquires the tank internal pressure detected by the pressure sensor 43. Then, in step S115, the ECM 40 determines whether the tank internal pressure is equal to or less than a predetermined threshold value. As the threshold value, a pressure equal to or higher than the maximum value of the intake manifold pressure during the low-load operation and lower than the atmospheric pressure is set as a value. When the tank internal pressure is equal to or less than the threshold value (YES), the ECM 40 increments the value of the normality counter C1 in step S120, clears the value of the abnormality counter C2 to 0, and then advances the process to step S130. If the tank internal pressure exceeds the threshold value (NO), the ECM 40 clears the value of the normality counter C1 to 0 in step S125, increments the value of the abnormality counter C2, and then advances the process to step S130. The value of the normality counter C1 indicates the duration of the state in which the tank internal pressure is equal to or less than the threshold value, and the value of the abnormality counter C2 indicates the duration of the state in which the tank internal pressure exceeds the threshold value.

In step S130, the ECM 40 determines whether the value of the normality counter C1 is equal to or greater than a predetermined normality determination value. When the value of the normality counter C1 is equal to or larger than the normality determination value (YES), the ECM 40 determines in step S135 that there is no abnormality in the first recirculation path 34, that is, determines that the first recirculation path 34 is normal, and then ends the process in the current control cycle. On the other hand, when the value of the normality counter C1 is less than the normality determination value (S130: NO), the ECM 40 determines in step S140 whether the abnormality counter C2 is equal to or greater than a predetermined abnormality determination value. When the value of the abnormality counter C2 is equal to or larger than the abnormality determination value (YES), the ECM 40 determines in step S145 that there is an abnormality in the first recirculation path 34, that is, performs abnormality determination, and then ends the process in the current control cycle. When it is determined that there is an abnormality, the ECM 40 notifies the driver of the occurrence of the abnormality by, for example, lighting a warning lamp.

### Operation of the First Embodiment

During low-load operation of the internal combustion engine 10, ventilation of the blow-by gas is performed by sucking the blow-by gas in the oil tank 30 through the first recirculation path 34 by the negative pressure in the intake manifold 23. Therefore, the tank internal pressure during the low-load operation becomes a negative pressure similar to that in the intake manifold 23.

When an abnormality occurs in the first recirculation path 34, such as disconnection and/or holes of piping, or closed sticking of the first PCV valve 35, the blow-by gas in the oil tank 30 is not drawn in by the negative pressure of the intake manifold 23. Therefore, when an abnormality occurs, the tank internal pressure does not become negative even during low-load operation of the internal combustion engine 10.

In contrast, in the diagnosis process, the ECM 40 checks whether the tank internal pressure during low-load operation exceeds a threshold value. The ECM 40 determines that there is an abnormality when the tank internal pressure exceeds the threshold value, thereby diagnosing the presence or absence of an abnormality in the first recirculation path 34. Therefore, when an abnormality occurs in the first recirculation path 34 as described above, the ECM 40 diagnoses that there is an abnormality.

### Advantages of the First Embodiment

The abnormality diagnosis device of the present embodiment can achieve the following effects.
(1) The ECM 40 performs the diagnosis process for diagnosing the presence or absence of an abnormality in the first recirculation path 34 based on whether the tank internal pressure during the low-load operation of the internal combustion engine 10 exceeds the threshold value. Therefore, the ECM 40 can diagnose the presence or absence of an abnormality in the first recirculation path 34 for recirculating the blow-by gas in the oil tank 30 to the intake passage 17, including a hole in the piping.
(2) The internal combustion engine 10, in which the abnormality diagnosis device of the present embodiment is employed, includes the first PCV valve 35, which is a one-way valve for preventing backflow of intake air from the intake passage 17 to the oil tank 30 in the first recirculation path 34. The first PCV valve 35 is disposed in a connecting portion of the first recirculation path 34 connected to the intake passage 17. It is assumed that the first PCV valve 35 is provided at a connecting portion of the first recirculation path 34 connected to the oil tank 30. In this case, when the piping constituting the first recirculation path 34 is detached or a hole is formed in the piping, outside air flows into the intake manifold 23 through the hole. Such inflow of outside air can be detected by a sensor already provided in the internal combustion engine, such as an air flow meter or an air-fuel ratio sensor. On the other hand, in a case where the first PCV valve 35 is installed at the connecting portion of the first recirculation path 34 connected to the intake passage 17, even when the disconnection and/or the holes of the piping occurs, the outside air does not flow into the intake manifold 23. Therefore, the existing sensor cannot diagnose an abnormality. The abnormality diagnosis device of the present embodiment can diagnose the presence or absence of an abnormality in the first recirculation path 34 even in the internal combustion engine 10 having a configuration in which an abnormality cannot be diagnosed by an existing sensor.
(3) The ECM 40 makes an abnormality/normality determination when a state in which the tank internal pressure exceeds the threshold value continues for a predetermined period of time or longer. Therefore, it is possible to suppress the influence of a temporary variation in the detection value of the tank internal pressure due to noise or disturbance on the diagnosis result and to improve the diagnosis accuracy.

### Second Embodiment

In order to accurately perform the abnormality diagnosis based on the tank internal pressure during the low-load operation, which is performed by the abnormality diagnosis device of the first embodiment, it is desirable to perform the diagnosis in a state in which the difference between the atmospheric pressure and the intake manifold pressure is larger than a certain degree. In the case of an internal combustion engine that performs intermittent operation control, such as a hybrid vehicle or a vehicle that performs idling stop control, the internal combustion engine is often stopped during low-load operation. Therefore, in the internal combustion engine in which the intermittent operation control is performed, an opportunity to perform the abnormality diagnosis under a preferable operation condition capable of ensuring diagnosis accuracy is limited. The abnormality diagnosis device of the present embodiment is configured to perform intermittent operation control to secure an opportunity for abnormality diagnosis in the internal combustion engine. The hardware configuration of the abnormality diagnosis device of the present embodiment is the same as that of FIG. 1. In the following description, in the present embodiment, components common to those of the first embodiment are denoted by the same reference numerals, and a detailed description thereof will be omitted.

In the present embodiment, the ECM 40 performs the abnormality diagnosis of the first recirculation path 34 through the preliminary diagnosis and the main diagnosis. Both the preliminary diagnosis and the main diagnosis are diagnoses of the presence or absence of an abnormality in the first recirculation path 34 based on the tank internal pressure. However, the execution condition of the preliminary diagnosis is set to be met in a situation where the execution condition of the preliminary diagnosis is easier to be met than the execution condition of the main diagnosis, but the diagnosis accuracy is low. In the present embodiment, the preliminary diagnosis is performed to determine whether the occurrence of an abnormality in the first recirculation path 34 is suspected, and the main diagnosis is performed to conclusively confirm the presence or absence of an abnormality in the first recirculation path 34.

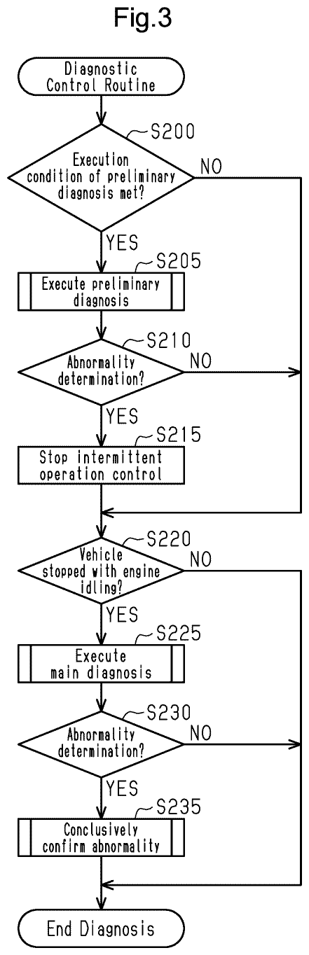

FIG. 3 shows a flowchart of a diagnostic control routine executed by the ECM 40 in the abnormality diagnosis device of the present embodiment. During the operation of the internal combustion engine 10, the ECM 40 repeatedly executes the processing of FIG. 3 at each predetermined control cycle.

When the ECM 40 starts this routine, first, in step S200, the SL determines whether the execution condition of the preliminary diagnosis is met. As the execution condition of the preliminary diagnosis, a condition in which the diagnosis based on the tank internal pressure can be executed but the execution condition of the main diagnosis is not met is set. Specifically, the execution condition of the preliminary diagnosis is set such that the engine is in a low-load operation in which the intake manifold pressure becomes a negative pressure and the engine is not in a vehicle stop idling state. When the execution condition of the preliminary diagnosis is met (YES), the ECM 40 proceeds to step S205. When the execution condition is not met (NO), the SL proceeds to step S220.

In step S205, the ECM 40 performs a preliminary diagnosis. The preliminary diagnosis is performed through the processing after step S110 in FIG. 2. Subsequently, in step S210, the ECM 40 determines whether it is determined in the preliminary diagnosis that there is an abnormality. When it is determined that there is an abnormality (YES), the ECM 40 stops the intermittent operation control of the internal combustion engine 10 in step S215, and then advances the process to step S220. On the other hand, when it is not determined that there is an abnormality (NO), the ECM 40 skips step S215 and advances the process to step S220.

In step S220, the ECM 40 determines whether the execution condition of the diagnosis is met. In the case of the present embodiment, a condition that the vehicle is in the idle stop state is set as the execution condition of the diagnosis. Then, the ECM 40 advances the process to step S225 when the execution condition of the diagnosis is met (YES), and ends the process of the routine in the current control cycle when the execution condition is not met (NO).

In step S225, the ECM 40 performs the present diagnosis. Similarly to the preliminary diagnosis, the main diagnosis is performed through the processing after step S110 in FIG. 2. However, in the case of the main diagnosis, the thresholds used for the determination in step S115 of FIG. 2 are set to be lower than those in the case of the preliminary diagnosis. Subsequently, in step S230, the ECM 40 determines whether it is determined that there is an abnormality in the main diagnosis. If it is determined that there is an abnormality (YES), the ECM 40 conclusively confirms the diagnostic result that there is an abnormality in the first recirculation path 34 in step S235, and then ends the processing of this routine in the current control cycle. On the other hand, when it is not determined that there is an abnormality in the present diagnosis (S230: NO), the ECM 40 skips step S235 and ends the processing of the present routine in the present control cycle.

### Operation of the Second Embodiment

In the internal combustion engine 10 that performs the intermittent operation control, since the operation of the internal combustion engine 10 is often stopped during the low-load operation, the opportunity to accurately perform the abnormality diagnosis of the first recirculation path 34 based on the tank internal pressure is limited. On the other hand, in the case of the present embodiment, even if the diagnostic accuracy cannot be ensured, the ECM 40 performs the preliminary diagnosis when a condition that allows the diagnosis based on the tank internal pressure is met. When it is determined that there is an abnormality in the preliminary diagnosis, it is considered that there is a high possibility that an abnormality has occurred, although it is not conclusively confirmed that an abnormality has occurred. When it is determined that there is an abnormality in the preliminary diagnosis, the ECM 40 stops the intermittent operation control of the internal combustion engine 10. When the intermittent operation control is stopped, the operation of the internal combustion engine 10 is continued even in the low-load operation region in which the operation is normally stopped. The ECM 40 performs the diagnosis when the intake manifold pressure is reduced to a level at which the diagnosis can be performed with high accuracy, that is, when the engine is stopped at idle. The ECM 40 performs the main diagnosis when the execution condition is met even during the intermittent operation control.

### Advantages of the Second Embodiment

The abnormality diagnosis device of the present embodiment can further exhibit the following effects in addition to the above-described effects (1) to (3).
(4) When it is determined in the preliminary diagnosis that there is an abnormality in a state in which the intermittent operation control of the internal combustion engine 10 is being performed, the ECM 40 stops the intermittent operation control and performs the main diagnosis in a state in which the intermittent operation control is stopped, thereby diagnosing the presence or absence of an abnormality in the first recirculation path 34. Therefore, even in the internal combustion engine 10 that performs the intermittent operation control, an opportunity for abnormality diagnosis of the first recirculation path 34 can be secured.
(5) the ECM 40 operates the internal combustion engine 10 at a low intake manifold pressure by stopping the intermittent operation control. Then, the ECM 40 performs this diagnosis when the internal combustion engine 10 is operated at a low intake manifold pressure. Therefore, since the intermittent operation control is performed, even in the internal combustion engine 10 in which the frequency of the operation at the low intake manifold pressure at which the diagnosis can be performed with high accuracy is low, the abnormality of the first recirculation path 34 can be diagnosed with high accuracy.

### Other Embodiments

The above embodiment may be modified as described below. The above embodiments and the following modifications can be combined as long as the combined modifications remain technically consistent with each other.

### Diagnostic Control Routine of FIG. 3

In the second embodiment, different values may be used as the normality determination value used for the determination in step S130 of FIG. 2 and the abnormality determination value used for the determination in step S140 of FIG. 2 between the case of the preliminary diagnosis and the case of the main diagnosis.

In the second embodiment, a condition other than during idling stop may be set as the execution condition of the main diagnosis as long as the diagnosis can be executed with higher accuracy than when the execution condition of the preliminary diagnosis is met.

### Diagnosis Process of FIG. 2

In the diagnosis process of FIG. 2, it is determined to be normal/abnormal when a state in which the tank internal pressure is equal to or less than the threshold value and a state in which it exceeds the threshold value continue for the predetermined period of time or long. The normality/abnormality may be determined only by the fact that the tank internal pressure is equal to or less than the threshold value or exceeds the threshold value without the condition that the tank internal pressure continues for the predetermined period of time or long.

In the diagnosis process, only the abnormality determination may be performed without performing the normality determination. In the diagnosis process in this case, for example, steps S120, S130, and S135 are omitted, and the processing procedure of FIG. 2 is changed so that the processing proceeds to step S125 after the processing of step S140.

Processing other than the notification to the driver may be performed when it is determined that there is an abnormality. For example, when it is determined that there is an abnormality, the output of the internal combustion engine 10 may be limited in order to reduce blow-by gas. Further, the operation of the internal combustion engine 10 may be restricted until the normality determination is made, and the restriction may be released in response to the normality determination.

### Ventilation System Configuration

The end of the first recirculation path 34 corresponding to the intake passage 17 may be connected to a portion other than the intake manifold 23 as long as the portion is located downstream of the throttle valve 22 in the intake passage 17.

The first PCV valve 35 may be provided at a portion of the first recirculation path 34 other than the connecting portion connected to the intake passage 17.

When the ventilation system is applied to a non-supercharged internal combustion engine, the second recirculation path 36 and/or the second PCV valve 37 may be omitted from the ventilation system of FIG. 1. Further, the vent valve 38 may be omitted.

### Others

The abnormality diagnosis device of the above embodiment and modifications can also be applied to an internal combustion engine having a different configuration from the internal combustion engine 10 of FIG. 1.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An abnormality diagnosis device configured to diagnose presence or absence of an abnormality in an internal combustion engine, the internal combustion engine including a dry sump lubrication system that circulates lubricating oil between the internal combustion engine and an oil tank outside the internal combustion engine, and the internal combustion engine being configured to recirculate blow-by gas in the oil tank to an intake passage, wherein
the abnormality diagnosis device comprises a pressure sensor that detects a tank internal pressure that is a pressure inside the oil tank, and
the abnormality diagnosis device is configured to perform a diagnosis process that diagnoses presence or absence of an abnormality in a recirculation path of the blow-by gas based on whether the tank internal pressure at a time of a low-load operation of the internal combustion engine exceeds a threshold value.

2. The abnormality diagnosis device for the internal combustion engine according to claim 1, wherein the internal combustion engine includes a one-way valve that is installed in a connecting portion of the recirculation path connected to the intake passage and is configured to prevent backflow of intake air from the intake passage to the oil tank.

3. The abnormality diagnosis device for the internal combustion engine according to claim 1, wherein the abnormality diagnosis device is configured to perform the diagnosis process after stopping an intermittent operation control of the internal combustion engine.

4. The abnormality diagnosis device for the internal combustion engine according to claim 1, wherein
the abnormality diagnosis device is configured to perform the diagnosis process in a state in which intermittent an operation control of the internal combustion engine is being performed, and
the abnormality diagnosis device is configured to perform, when the diagnosis process diagnoses that there is an abnormality in the recirculation path, the diagnosis process again in a state in which the intermittent operation control is stopped.

5. The abnormality diagnosis device for the internal combustion engine according to claim 1, wherein the diagnosis process includes diagnosing that there is an abnormality in the recirculation path when a state in which the tank internal pressure exceeds the threshold value continues for a predetermined period of time or longer.
